(19) United States
(12) Patent Application Publication
(10) Pub. No.: US 2018/0105664 A1
(43) Pub. Date: Apr. 19, 2018

(54) BUILDING COMPONENTS AND METHODS FOR MAKING

(71) Applicant: Pella Corporation, Pella, IA (US)

(72) Inventor: Paul D. Schroder, Pella, IA (US)

(21) Appl. No.: 15/784,386

(22) Filed: Oct. 16, 2017

Related U.S. Application Data
(60) Provisional application No. 62/410,197, filed on Oct. 19, 2016.

(51) Int. Cl. B29C 71/02; E06B 3/44

(52) U.S. Cl. CPC C08J 7/08; C08J 2327/06; E06B 3/4415

(57) ABSTRACT

A method for treating an extruded or molded building component, the building component formed of a substantially amorphous thermoplastic having a glass transition temperature above room temperature. The method includes heating the building component from room temperature to a treatment temperature between room temperature and the glass transition temperature, maintaining the building component at the treatment temperature for a treatment time while supporting the building component to prevent sagging, and cooling the building component from the treatment temperature. The building component does not reach the glass transition temperature after reaching the treatment temperature.

### CROSS REFERENCE TO RELATED APPLICATION

This application claims priority to U.S. Provisional Application No. 62/410,197, filed Oct. 19, 2016, which is herein incorporated by reference in its entirety.

### TECHNICAL FIELD

Examples of the present invention relate generally to building components for building products. Specifically, examples relate to thermoplastic building components for building products.

### BACKGROUND

Building products, for example, fences, decks, and fenestration products such as windows, skylights, doors, louvers, and vents, may include thermoplastic components. For example, fenestration products may include frame components, such as, for example, jambs, heads, sash stiles, and sash rails. In some fenestration products, the frame components can be formed of extruded or molded thermoplastics, such as polyvinyl chloride (PVC). Fenestration products with thermoplastic frame components can be more energy efficient than those made of alternative materials because the thermoplastic frame components may conduct heat more slowly than frame components made of the alternative materials. Thermoplastic building components may also be easier to manufacture and may be more weather resistant.

### SUMMARY

Example 1 is a method for treating an extruded or molded building component, the building component formed of a substantially amorphous thermoplastic having a glass transition temperature above room temperature. The method includes heating the building component from room temperature to a treatment temperature between room temperature and the glass transition temperature, maintaining the building component at the treatment temperature for a treatment time while supporting the building component to prevent sagging, and cooling the building component from the treatment temperature. The building component does not reach the glass transition temperature after reaching the treatment temperature.

Example 2 is the method of Example 1, wherein the amorphous thermoplastic is polyvinyl chloride.

Example 3 is the method of Example 2, wherein the treatment temperature ranges from about 55° C. to about 75° C.

Example 4 is the method of any of Examples 1-3, wherein the treatment time ranges from about 1 hour to about 168 hours.

Example 5 is the method of any of Examples 1-4, wherein the building component is maintained at the treatment temperature for the treatment time in an environment at a pressure greater than atmospheric pressure.

Example 6 is the method of any of Examples 1-5, wherein the building component is maintained at the treatment temperature for the treatment time in an inert atmosphere.

Example 7 is a building component including an extruded or molded, substantially amorphous thermoplastic having a glass transition temperature above room temperature, wherein the building component is densified without sagging. The building component exhibits a creep compliance when heated from 30° C. to 60° C. in less than about 12 hours that is less than half the creep compliance of the building component without being densified.

Example 8 is the building component of Example 7, wherein the amorphous thermoplastic is polyvinyl chloride.

Example 9 is the building component of Example 8, wherein the polyvinyl chloride exhibits an enthalpy of transition of at least 2.72 J/g.

Example 10 is the building component of any of Examples 7-9, wherein the building component is a lower rail of an upper sash of a single-hung or a double-hung window.

In Example 11, the building component of any of Examples 7-10, wherein the building component retains substantially all of any residual stresses resulting from being extruded or molded.

Example 12 is a fenestration product including a frame component, wherein the frame component is an extruded or molded, substantially amorphous thermoplastic having a glass transition temperature above room temperature, wherein the frame component is densified without sagging and exhibits a creep compliance when heated from 30° C. to 60° C. in less than about 12 hours that is less than half the creep compliance of the frame component without being densified.

Example 13 is the fenestration product of Example 12, wherein the fenestration product is a single-hung or double-hung window including an upper sash and a lower sash, and the frame component is a lower rail of the upper sash.

Example 14 is the fenestration product of either of Examples 12 or 13, wherein the frame component retains substantially all of any residual stresses resulting from being extruded or molded.

Example 15 is the fenestration product of any of Examples 12-14, wherein the frame component is densified by treating the frame component for a treatment time at a treatment temperature between room temperature and the glass transition temperature of the thermoplastic, wherein the frame component does not reach the glass transition temperature after being extruded or molded.

Example 16 is the fenestration product of Example 15, wherein the amorphous thermoplastic is polyvinyl chloride.

Example 17 is the fenestration product of Example 16, wherein the polyvinyl chloride exhibits an enthalpy of transition of at least 2.72 J/g.

Example 18 is the fenestration product of either of Examples 16-17, wherein the treatment temperature ranges from about 55° C. to about 75° C.

Example 19 is the fenestration product of any of Examples 15-17, wherein the treatment time ranges from about 24 hours to about 168 hours.

Example 20 is the fenestration product of any of Examples 15-19, wherein the frame component is maintained at the treatment temperature for the treatment time in an inert atmosphere.

While multiple examples are disclosed, still other examples of the present invention will become apparent to those skilled in the art from the following detailed description, which shows and describes illustrative examples of the invention. Accordingly, the drawings and detailed description are to be regarded as illustrative in nature and not restrictive.

### BRIEF DESCRIPTION OF THE DRAWINGS

FIG. 1 shows fenestration product including frame components, according to some examples.

FIG. 2 is a graph illustrating relative creep compliance of frame components densified according to some examples compared to frame components that have not been densified.

FIG. 3 is another graph illustrating relative creep compliance of frame components densified according to some examples compared to frame components that have not been densified.

FIG. 4 is a graph of impact energy as a function of treatment time according to some examples.

FIG. 5 is another graph of impact energy as a function of treatment time according to some examples.

FIG. 6 is a graph of heat flow as a function of temperature for a test sample that was not densified.

FIG. 7 is a graph of heat flow as a function of temperature for a test sample that was densified, according to some examples.

FIG. 8 is a graph of enthalpy of a glass transition as a function of densification time for PVC samples from each of four suppliers.

### DETAILED DESCRIPTION

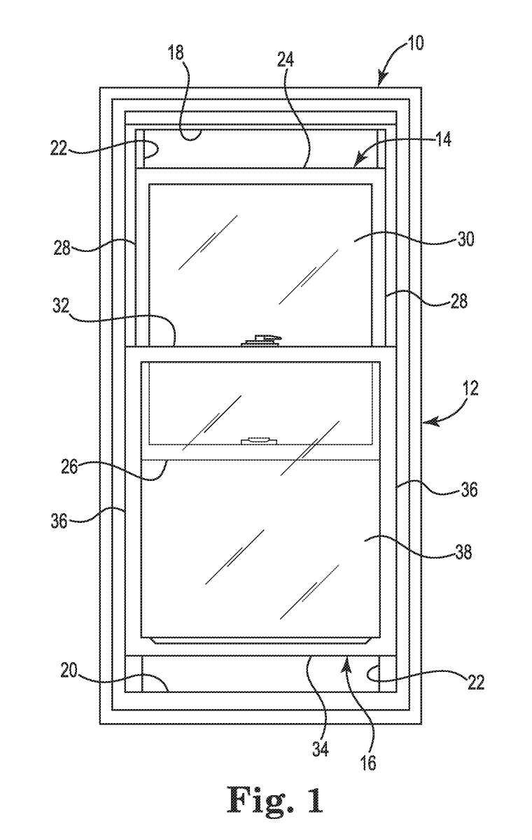

FIG. 1 is an interior-facing view of a building product—a fenestration product, window 10, according to some examples. As shown in FIG. 1, the window 10 can include a fenestration frame 12, an upper sash 14, and a lower sash 16. The fenestration frame 12 can include a head 18, a sill 20, and jambs 22. The head 18, the sill 20, and the jambs 22 are frame components of the window 10. Together, the head 18, the sill 20, and the jambs 22 surround and support the upper sash 14 and the lower sash 16. The upper sash 14 can include an upper rail 24, a lower rail 26, stiles 28, and window pane 30. The upper rail 24, the lower rail 26, and the stiles 28 are also frame components of the window 10. Together, the upper rail 24, the lower rail 26, and the stiles 28 surround and support the window pane 30. The lower sash 16 can include an upper rail 32, a lower rail 34, stiles 36, and window pane 38. The upper rail 32, the lower rail 34, and the stiles 36 are also frame components of the window 10. Together, the upper rail 32, the lower rail 34, and the stiles 36 surround and support the window pane 38.

In use, the upper sash 14 and the lower sash 15 may be moved vertically within the fenestration frame 12 to open or close areas of the window 10. In FIG. 1, the upper sash 14 is shown moved downward from the head 18 to provide an opening near the top of the window 10, and the lower sash 16 is shown moved upward from the sill 20 to provide an opening near the bottom of the window 10. The upper sash 14 can be moved fully upward to be in contact with the head 18 and the lower sash 16 can be moved fully downward to be in contact with the sill 20, bringing the lower rail 26 of upper sash 14 and the upper rail 32 of the lower sash 16 into alignment to fully close the window 10.

The window 10 may be configured to be stored and shipped fully closed and in a vertical orientation. So configured, each of the framing components are generally vertically oriented or horizontally oriented. The jambs 22, the stiles 28, and the stiles 36 may be vertically oriented. The upper rail 24 and the lower rail 26 of the upper sash 14, the upper rail 32 and the lower rail 34 of the lower sash 16, the head 18, and the sill 20 may be horizontally oriented. During transit or in service, the window 10 may experience temperatures as high as 70° C. or higher for an extended period of time.

In examples, at least some of the frame components may be formed by extrusion or molding of a substantially amorphous thermoplastic having an glass transition temperature (Tg) above room temperature, such as polyvinyl chloride (PVC). The Tg should be higher than temperatures expected in normal use so that the frame component maintains its rigidity. PVC is an amorphous or “glassy” polymer that is not in thermodynamic equilibrium when cooled below its Tg of about 80° C. Frame components formed of PVC, although rigid, may continue to slowly flow or creep at temperatures below Tg, especially when exposed to temperatures approaching Tg. It has been found that horizontally oriented PVC frame components, especially those unsupported along their length, such as the lower rail 26 of the upper sash 14, may creep so much that they sag along their length as a result of the high temperature exposure during transit and/or in service.

Amorphous thermoplastics, such as PVC, are considered to be super cooled, solidified liquids whose volumes are greater than they would be at equilibrium. It has been found that by densifying a PVC frame component, such as the lower rail 26, the frame component becomes stiffer, exhibiting a creep compliance that is less than half the creep compliance of the frame component without being densified. Creep compliance is defined as the ratio of strain to stress as a given point in time the frame component formed of a substantially amorphous thermoplastic. Densified frame components in accordance with examples may exhibit less creep or sagging when exposed to high-temperatures during transit because of the increased stiffness.

In some examples, frame components, such as the lower rail 26, may be extruded and cut into final form, and then treated by heating the frame component from room temperature to a treatment temperature between room temperature and Tg of the amorphous thermoplastic. The frame component can be maintained at the treatment temperature for a treatment time sufficient to densify the frame component. The frame component can be supported along its length to prevent sagging during the treatment. Once the treatment time is completed, the frame component can be cooled (or permitted to cool) from the treatment temperature to room temperature and used in a fenestration product, such as the window 10.

In examples, once the treatment time at the treatment temperature is completed, the frame component does not reach Tg. This is, in part, to ensure that unpredictable residual stresses frozen into the frame component as a result of the extrusion process are retained in the frame component and are not expressed when Tg is reached and the frame component is no longer rigid. Release of the unpredictable stresses may warp the frame component, making it unusable.

Generally, the treatment time can be as short as about 1 hour, about 24 hours, about 48 hours, or about 72 hours, or as long as about 120 hours, about 144 hours, about 168 hours, or about 192 hours, or can be within any range defined between any pair of the foregoing values. In some examples, the treatment time can range from about 1 hour to about 192 hours, about 24 hours to about 168 hours, about 48 hours to about 144 hours, or about 72 hours to about 120 hours. In some examples, the treatment time can be about 96 hours.

In examples in which the thermoplastic is PVC, the treatment temperature may be as low as about 55° C., or about 60° C., or as high as about 70° C. or about 75° C., or the treatment temperature may be within any range defined between any pair of the foregoing values. In some examples, the treatment temperature can range from about 55° C. to about 75° C., or about 60° C. to about 70° C. In some examples, the treatment temperature can be about 65° C.

In some examples, densification of the frame component may be further enhanced by maintaining the frame component in an environment at a pressure greater than atmospheric pressure while the frame component is maintained at the treatment temperature for the treatment time. Additionally or alternatively, the frame component may be maintained in an atmosphere of an inert gas that will not promote degradation of the thermoplastic while the frame component is maintained at the treatment temperature for the treatment time. In some examples, the inert gas may be nitrogen gas, argon gas, or a combination of nitrogen and argon gases.

Although the window 10 shown in FIG. 1 is illustrated as a double-hung window, examples also include a single-hung window which differs from the above description only in that the upper sash 14 does not move vertically.

The examples described above were directed to the lower rail 26 of the upper sash 14 of the window 10. However, it is understood that examples can include any of the other frame components described above, any of which may benefit from reduced creep compliance and increased stiffness. It is also understood that examples can include other fenestration products having frame components, such as patio doors, skylights, doors, louvers, vents, and other windows. It is further understood that examples can include other building components of other building products, for example, boards for decks and posts and rails for fences.

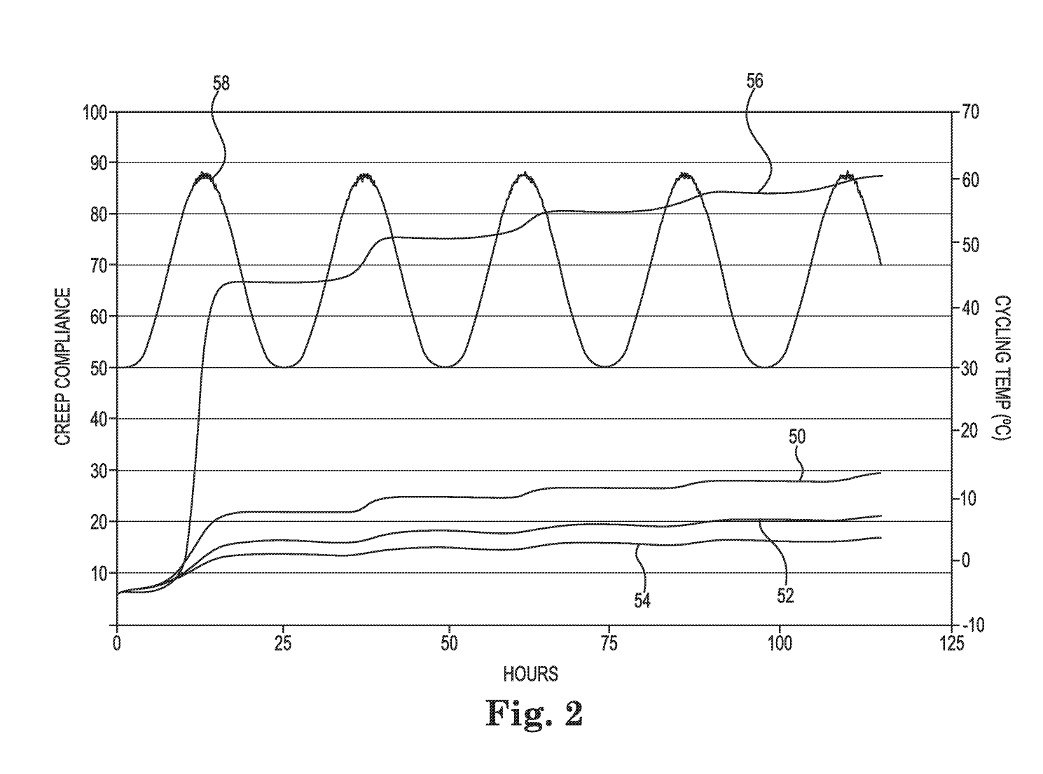

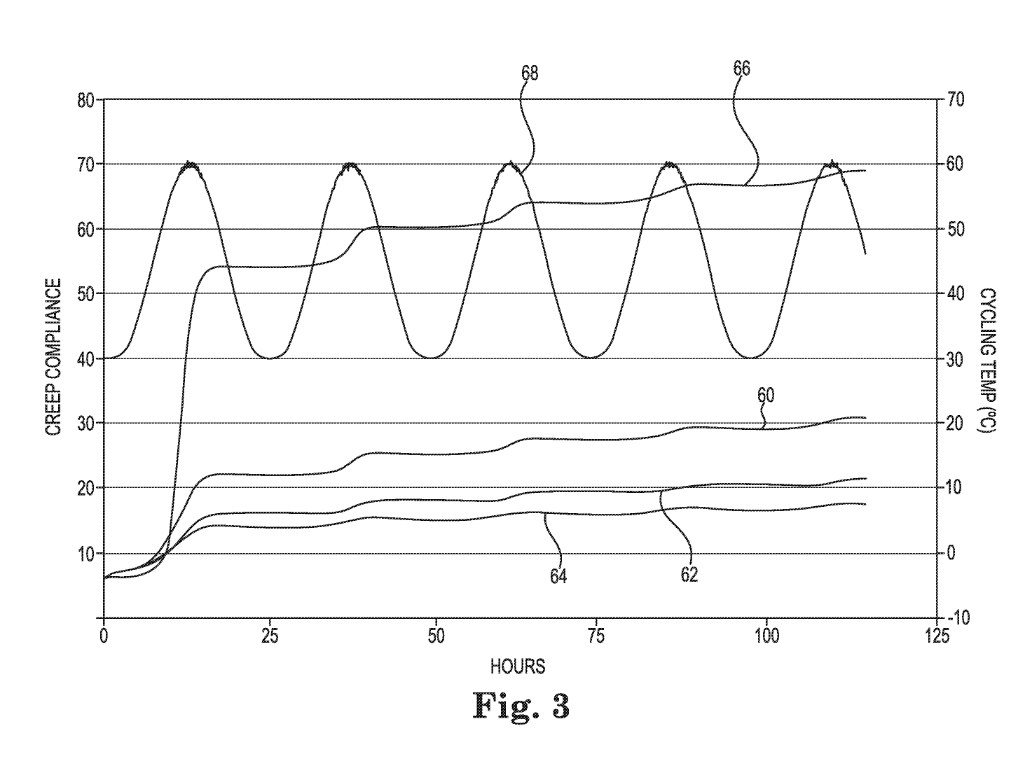

FIGS. 2 and 3 are graphs illustrating relative creep compliance of frame components densified as described above compared to frame components that have not been densified. The frame components in FIG. 2 were formed of PVC from one supplier, supplier A, and those in FIG.3 were formed of PVC from another supplier, supplier B.

FIG. 2 shows compliance over time and temperature for three frame component samples according to examples, and one control frame component that was not densified. Sample 50 shows the compliance for a frame component in accordance with examples, densified at a treatment temperature of 65° C. for a treatment time of 1 hour. Sample 52 shows the compliance for a frame component in accordance with examples, densified at a treatment temperature of 65° C. for a treatment time of 6 hours. Sample 54 shows the compliance for a frame component densified in accordance with examples, at a treatment temperature of 65° C. for a treatment time of 24 hours. Control 56 shows the compliance of a frame component that has not been densified. The four frame components were temperature cycled from 30° C. to 60° C. for about 5 cycles over a period of about 114 hours, as shown by temperature 58, to accelerate creep while a constant stress was applied. The frame components were heated from 30° C. to 60° C. in less than about 12 hours, as shown in FIG. 2. The movement, or creep, of the frame components resulting from the applied stress was measured during the temperature cycling, and a compliance determined. FIG. 2 shows normalized creep compliance values with lower creep compliance values indicative of less movement of the frame component, suggesting less creep or sagging when exposed to similarly high temperatures in transit. As shown in FIG. 2, the vast majority of the creep occurs at elevated temperatures, particularly as the temperature exceeds about 50° C. As also shown in FIG. 2, the Samples 50, 52, and 54 each show a creep compliance that is less than half that of the Control 56 at the elevated temperatures.

FIG. 3 shows compliance over time and temperature for three frame component samples according to examples, and one control frame component that was not densified. As noted above, the frame components of FIG. 3 were formed of PVC from different supplier than the frame components of FIG. 2. Sample 60 shows the compliance for a frame component in accordance with examples, densified at a treatment temperature of 65° C. for a treatment time of 1 hour. Sample 62 shows the compliance for a frame component in accordance with examples, densified at a treatment temperature of 65° C. for a treatment time of 6 hours. Sample 64 shows the compliance for a frame component densified in accordance with examples, at a treatment temperature of 65° C. for a treatment time of 24 hours. Control 66 shows the compliance of a frame component that has not been densified. The four frame components were temperature cycled from 30° C. to 60° C. for about 5 cycles over a period of about 114 hours, as shown by temperature 68, to accelerate any creep while a constant stress was applied. The frame components were heated from 30° C. to 60° C. in less than about 12 hours, as shown in FIG. 3. As with FIG. 2, FIG. 3 shows normalized creep compliance values with lower creep compliance values indicative of less movement of the frame component, suggesting less creep or sagging when exposed to similarly high temperatures in transit. As shown in FIG. 3, the Samples 60, 62, and 64 each show a creep compliance that is less than half that of the Control 66. Considering FIGS. 2 and 3 together, it is apparent that PVC from two different suppliers shows similar results.

It has also been found that densified PVC frame components in accordance with examples treated at 65° C. for up to 96 hours do not exhibit brittle failure based on a notched Izod impact strength test per ASTM D265. An increase in brittleness could result in reduced impact strength or toughness.

A dropped dart impact test was also employed to evaluate any change in brittleness in PVC as a result of increasing treatment times. The dropped dart impact test used a Gardner Impact Tester with a ½ inch punch, 0.640 inch base and a 2.7279 kg mass. All tests were done at room temperature. PVC frame components were impacted from increasing heights until failure, and then the resulting failure height was used to calculate an impact energy required to cause the brittle failure, with lower impact energies indicating greater brittleness of a PVC frame component. Densified PVC frame components treated at 65° C. for 24 hours and 168 hours were tested. PVC frame components that were not densified were also tested for comparison.

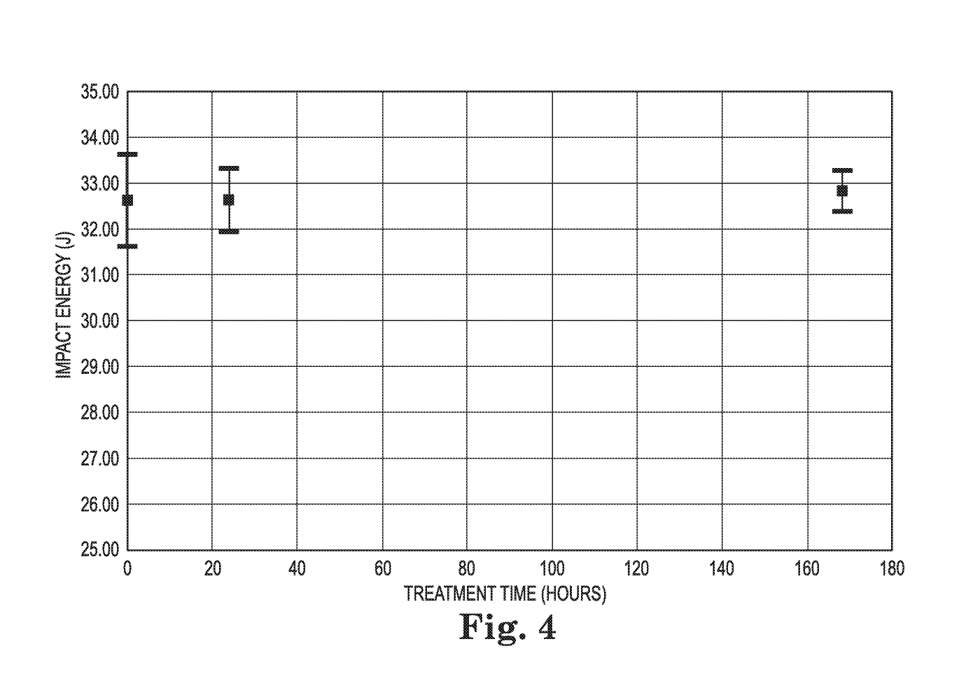

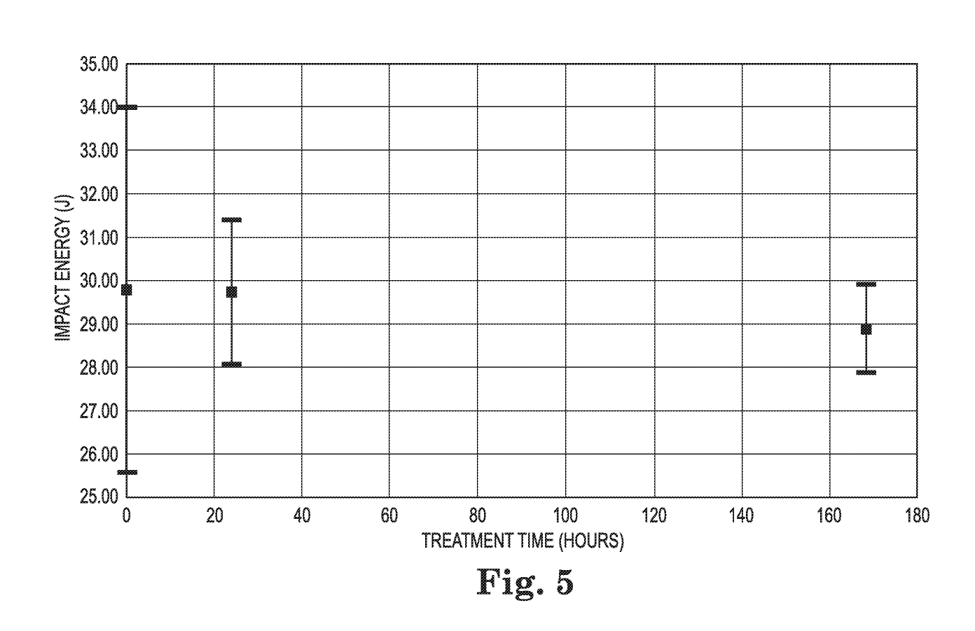

FIGS. 4 and 5 are graphs of impact energy as a function of treatment time for frame components densified as described above compared to frame components that were not been densified. The frame components in FIG. 4 were formed of the PVC from supplier A, and those in FIG. 5 were formed of the PVC from supplier B. The data represented in FIGS. 4 and 5 are mean impact energies with error bars representing three standard deviations on either side of the mean. Each data point represents test results from 15 to 20 test samples. The PVC frame components that were not densified are shown at zero hours of treatment time. As shown in both FIGS. 4 and 5, PVC frame components densified according to embodiments show no significant decrease in the impact energy required to cause brittle failure. Comparing FIGS. 4 and 5, it is apparent that PVC from two different suppliers shows similar results.

Differential scanning calorimetry (DSC) is an analytical technique that is well known in the art. In DSC, a sample test material and a sample reference material with well-known thermal characteristics are simultaneously heated over a range of temperatures while the amount of heat required to increase the temperature of each sample is measured and compared. In this way, a precise measurement of the enthalpy of material transitions can be obtained. DSC can be used to identify materials based on their thermal properties. It has been found that DSC can be used to distinguish between PVC frame components that have been densified as described above, and frame components that have not been densified.

PVC samples were obtained from each of four different PVC suppliers (A, B, C, and D). Some samples from each supplier were densified as described above for 24 hours and other samples were densified for 168 hours. The samples were densified at a temperature of 65° C. Some samples from each supplier were not densified. The samples were run twice over a temperature range of room temperature to about 200° C. using a Diamond Differential Scanning calorimeter from PerkinElmer. Graphs of heat flow as a function of temperature were obtained from the test for each sample.

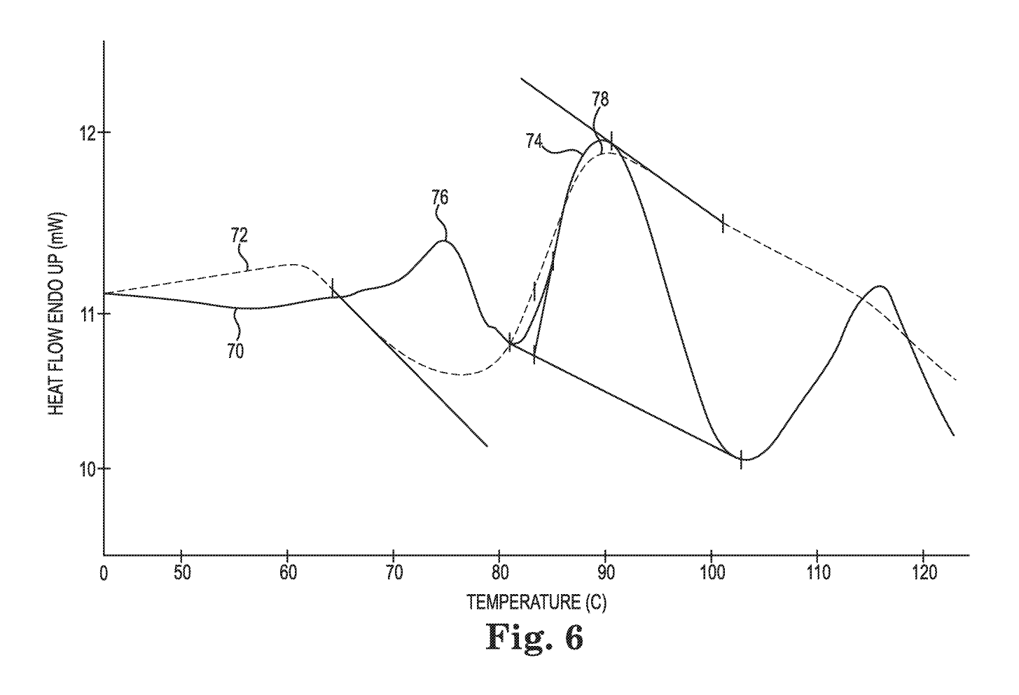

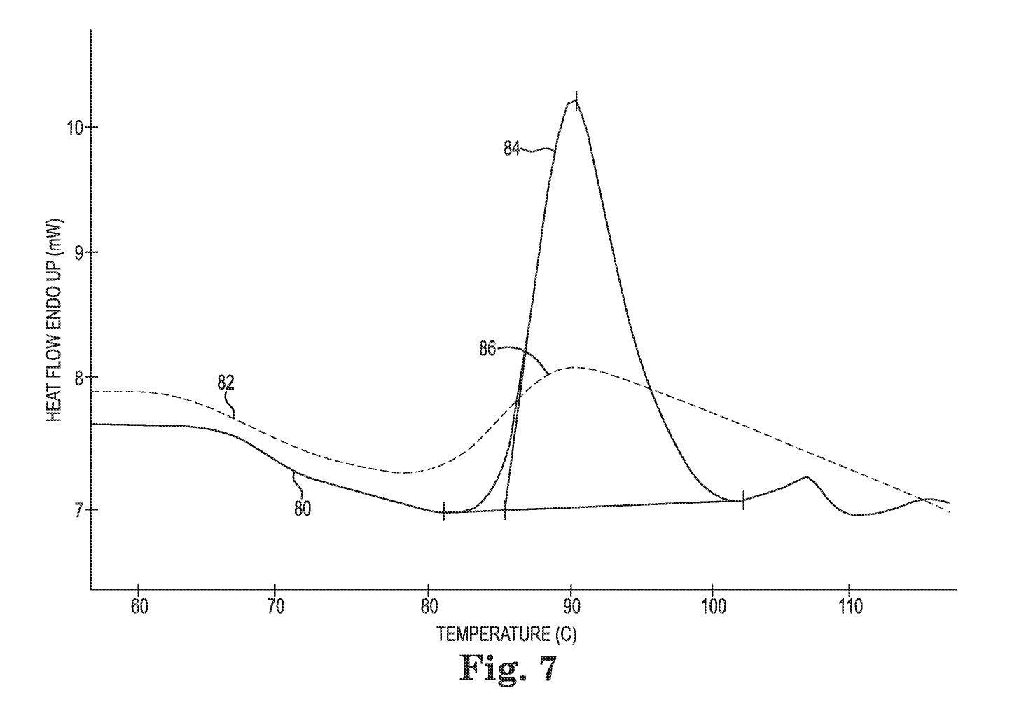

FIGS. 6 and 7 are examples of the portions of the graphs obtained from DSC testing including a glass transition peak extending from about 80° C. to about 100° C. FIG. 6 shows a typical graph of heat flow as a function of temperature for a test sample that was not densified. FIG. 6 shows a first run, or heat 70 and a second run, or heat, 72. The second heat 72 illustrates the PVC after it is annealed because the first heat 70 anneals the PVC by taking it well beyond its glass transition temperature. The first heat 70 shows a glass transition peak 74 and a sub-glass transition peak 76. The second heat 72 shows a glass transition peak 78 that appears to be similar in size to the glass transition peak 74 of the first heat 70, indicating that the magnitude of the enthalpy of the material transition around the glass transition temperature is relatively unchanged between the PVC sample in the initial state and the PVC sample after the PVC is annealed.

As shown in FIG. 6, the second heat 72 shows no sub-glass transition peak comparable to the sub-glass transition peak 76 observed during the first heat 70. The physical characteristic present in the PVC samples in their initial state that caused the sub-glass transition shown by the sub-glass transition peak 76 is absent once the PVC is annealed. The disappearance of the sub-glass transition temperature peak, as well as the relatively constant magnitude of the enthalpy of the glass transition of the undensified PVC before and after annealing, were observed with all of the PVC samples tested, regardless of whether the PVC came from supplier A, B, C. or D.

FIG. 7 shows a typical graph of heat flow as a function of temperature for a test sample that was densified for 24 hours, as described above. FIG. 7 shows a first heat 80 and a second heat 82. As with FIG. 6, the second heat 82 illustrates the PVC after it is annealed because the first heat 80 anneals the PVC by taking it well beyond its glass transition temperature. The first heat 80 shows a glass transition peak 84. The second heat 82 shows a glass transition peak 86. Unlike the undensified PVC of FIG. 6, the densified PVC of FIG. 7 shows no sub-glass transition peak during the first heat 80.

As shown in FIG. 7, the glass transition peak 84 of the first heat 80 is much larger than the glass transition peak 86 of the second heat 82. This demonstrates that the magnitude of the enthalpy of the material transition around the glass transition temperature is significantly greater in the densified PVC sample compared to the PVC sample after the PVC is annealed. It is believed that the annealing the PVC and cooling it down to below Tg returns the PVC to its original undensified state. The lack of a sub-glass transition temperature peak, as well as the significantly larger magnitude of the enthalpy of the glass transition of the densified PVC, were observed with all of the PVC samples densified for either 24 hours or 168 hours, and regardless of whether the PVC came from supplier A, B, C. or D.

The enthalpies of the glass transitions were determined for each of the test samples from the first heats of the DSC tests. The enthalpy of the glass transition for PVC samples that had not been densified ranged from 0.61 to 2.08 Joules per gram (J/g) with an average of 1.16 J/g and a standard deviation of 0.51 J/g. The enthalpy of the glass transition for PVC samples that had been densified for 24 hours ranged from 3.31 to 4.27 J/g with an average of 3.90 J/g and a standard deviation of 0.32 J/g. The enthalpy of the glass transition for PVC samples that had been densified for 168 hours ranged from 3.80 to 5.88 J/g with an average of 4.44 J/g and a standard deviation of 0.63 J/g. Thus, PVC that exhibits an enthalpy of glass transition ranging from at least 3.31 to 5.88 J/g has been densified in accordance with embodiments described above. Considering the 24 hour and 168 hour densified samples as a group and comparing them to the undensified samples, and assuming a normal distribution of enthalpies for the densified and undensified PVC samples, then PVC frame components that exhibit an enthalpy of glass transition greater than 2.72 J/g have been densified in accordance with embodiments described above with a certainty of at least 99%.

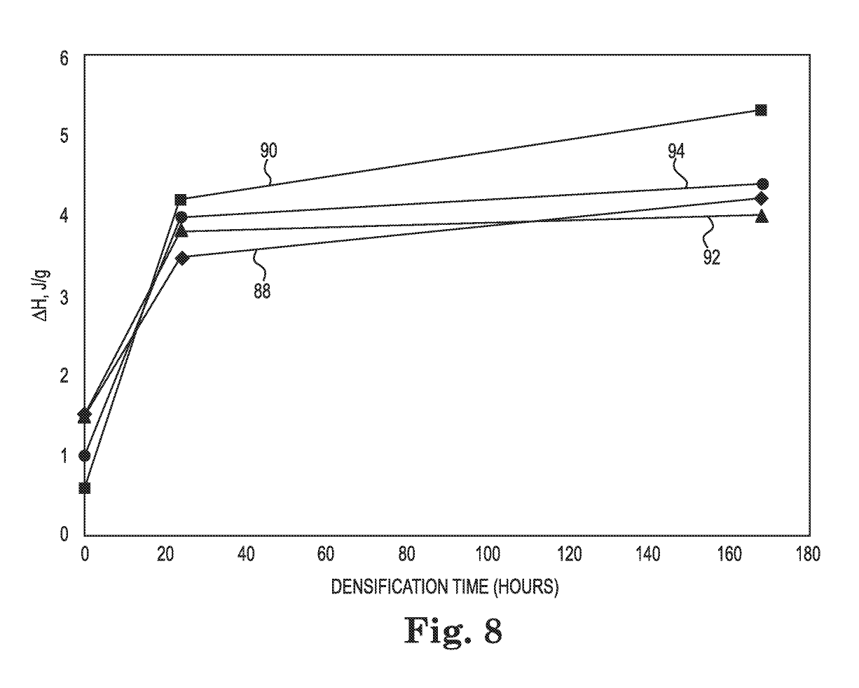

The contrast in the enthalpy of the glass transition between the densified and undensified samples is shown in FIG. 8. FIG. 8 is a graph of the enthalpy for the glass transition as a function of densification time for samples from each of four suppliers A, B, C, and D. FIG. 8 includes line 88 for supplier A, line 90 for supplier B, line 92 for suppler C, and line 94 for suppler D. For each of the lines 88, 90, 92, and 94, data points are shown at 0 hours of densification time (undensified PVC), 24 hours of densification time, and 168 hours of densification time. Each data point represents two samples. Thus, as shown in FIG. 8, the enthalpy of the glass transition for densified PVC is significantly greater than that for undensified PVC. Without wishing to be bound by any theory, it is believed that the denser, stiffer PVC requires more energy to unstiffen and become flexible through the glass transition.

Various modifications and additions can be made to the examples discussed without departing from the scope of the present invention. For example, while the examples described above refer to particular features, the scope of this invention also includes examples having different combinations of features and examples that do not include all of the above described features.

I claim:

1. A method for treating an extruded or molded building component, the building component formed of a substantially amorphous thermoplastic having a glass transition temperature above room temperature, the method comprising:
heating the building component from room temperature to a treatment temperature between room temperature and the glass transition temperature;
maintaining the building component at the treatment temperature for a treatment time while supporting the building component to prevent sagging; and
cooling the building component from the treatment temperature,
wherein the building component does not reach the glass transition temperature after reaching the treatment temperature.

2. The method of claim 1, wherein the amorphous thermoplastic is polyvinyl chloride.

3. The method of claim 2, wherein the treatment temperature ranges from about 55° C. to about 75° C.

4. The method of claim 1, wherein the treatment time ranges from about 1 hour to about 192 hours.

5. The method of claim 1, wherein the building component is maintained at the treatment temperature for the treatment time in an environment at a pressure greater than atmospheric pressure.

6. The method of claim 1, wherein the building component is maintained at the treatment temperature for the treatment time in an inert atmosphere.

7. A building component comprising:
an extruded or molded, substantially amorphous thermoplastic having a glass transition temperature above room temperature, wherein the building component is densified without sagging, wherein the building component exhibits a creep compliance when heated from 30° C. to 60° C. in less than about 12 hours that is less than half the creep compliance of the building component without being densified.

8. The building component of claim 7, wherein the amorphous thermoplastic is polyvinyl chloride.

9. The building component of claim 8, wherein the polyvinyl chloride exhibits an enthalpy of transition of at least 2.72 J/g.

10. The building component of claim 7, wherein the building component is a lower rail of an upper sash of a single-hung or a double-hung window.

11. The building component of claim 7, wherein the building component retains substantially all of any residual stresses resulting from being extruded or molded.

12. A fenestration product comprising:
a frame component, wherein the frame component is an extruded or molded, substantially amorphous thermoplastic having a glass transition temperature above room temperature, wherein the frame component is densified without sagging and exhibits a creep compliance when heated from 30° C. to 60° C. in less than about 12 hours that is less than half the creep compliance of the frame component without being densified.

13. The fenestration product of claim 12, wherein the fenestration product is a single-hung or double-hung window including an upper sash and a lower sash, and the frame component is a lower rail of the upper sash.

14. The fenestration product of claim 12, wherein the frame component retains substantially all of any residual stresses resulting from being extruded or molded.

15. The fenestration product of claim 12, wherein the frame component is densified by treating the frame component for a treatment time at a treatment temperature between room temperature and the glass transition temperature of the thermoplastic, wherein the frame component does not reach the glass transition temperature after being extruded or molded.

16. The fenestration product of claim 15, wherein the amorphous thermoplastic is polyvinyl chloride.

17. The fenestration product of claim 16, wherein the polyvinyl chloride exhibits an enthalpy of transition of at least 2.72 J/g.

18. The fenestration product of claim 16, wherein the treatment temperature ranges from about 55° C. to about 75° C.

19. The fenestration product of claim 15, wherein the treatment time ranges from about 1 hours to about 192 hours.

20. The fenestration product of claim 15, wherein the frame component is maintained at the treatment temperature for the treatment time in an inert atmosphere.
